(19) United States
(12) Patent Application Publication
(10) Pub. No.: US 2025/0141735 A1
(43) Pub. Date: May 1, 2025

(54) ELECTRONIC APPARATUS AND CONTROLLING METHOD THEREOF

(71) Applicant: Samsung Electronics Co., Ltd., Suwon-si (KR)

(72) Inventors: Soosin HWANG, Suwon-si (KR); Ilyong PARK, Suwon-si (KR); Jeongsoo LEE, Suwon-si (KR); Jaehwan SIM, Suwon-si (KR); Jongjik LEE, Suwon-si (KR)

(73) Assignee: Samsung Electronics Co., Ltd., Suwon-si (KR)

(21) Appl. No.: 18/968,142

(22) Filed: Dec. 4, 2024

Related U.S. Application Data
(63) Continuation of application No. PCT/KR2024/016476, filed on Oct. 25, 2024.

(30) Foreign Application Priority Data
Nov. 1, 2023 (KR) 10-2023-0149077

(51) Int. Cl. H04L 41/08

(52) U.S. Cl. CPC H04L 41/08

(57) ABSTRACT

An electronic apparatus including a communication interface, a memory configured to store at least one instruction, and a processor connected to the memory to control the electronic apparatus, and the processor is configured to, based on a resource state of a first hub device, among a plurality of hub devices, having a resource condition unsatisfied to support control of an external device connected to the first hub device, transmit a signal to disconnect the external device from the first hub device through the communication interface, and transmit a signal c to connect the external device to a second hub device, among the plurality of hub devices, having a resource state that satisfies the resource condition to support the control of the external device through the communication interface.

### CROSS-REFERENCE TO RELATED APPLICATION

This application is a continuation application, under 35 U.S.C. § 111(a), of international application No. PCT/KR2024/016476, filed on Oct. 25, 2024, which claims priority under 35 U. S. C. § 119 to Korean Patent Application No. 10-2023-0149077, filed on Nov. 1, 2023, the disclosures of which are incorporated herein by reference in their entireties.

### BACKGROUND

### Field

The present disclosure relates to an electronic apparatus and a controlling method thereof, and more particularly, to an electronic apparatus that adjusts a hub device to which an external device is connected based on resource states of a plurality of hub devices and a controlling method thereof.

### Description of the Related Art

With the development of electronic technology, various types of electronic products are being developed and popularized. For example, the use of various terminal devices such as smartphones, smart pads (tablets), PDAs, etc. is gradually expanding. These terminal devices are not limited in their functionality, and can be modified and/or expanded through various applications.

Internet of Things (also known as IoT) refers to technologies and services for sharing information by connecting a variety of things, i.e., devices including home appliances and electronic apparatuses via network.

An external device may be connected to a hub device to perform various forms of operations.

### SUMMARY

An electronic apparatus according to one or more embodiments includes a communication interface, a memory configured to store at least one instruction, and a processor connected to the memory to control the electronic apparatus, and the processor is configured to, based on a resource state of a first hub device, among a plurality of hub devices, having a resource condition unsatisfied to support control of an external device connected to the first hub device, transmit a signal to disconnect the external device from the first hub device through the communication interface, and transmit a signal to connect the external device to a second hub device, among the plurality of hub devices, having a resource state that satisfies the resource condition to support the control of the external device through the communication interface.

The processor may be configured to, based on a request to connect one of the plurality of hub devices to the external device being received from the external device, transmit a signal to the first hub device as the one of the plurality of hub devices having a resource required to support an operation of the external device through the communication interface.

The resource required to support the operation of the external device may be a computing device enabled to support the operation of the external device.

The resource required to support the operation of the external device may be a communication interface that performs communication according to a communication protocol through which the external device performs communication.

The processor may be configured to, transmit the signal to disconnect the external device from the first hub device through the communication interface, based on an available resource of the first hub device being less than a resource required to control the external device.

The processor may be configured to, transmit the signal to disconnect the external device from the first hub device through the communication interface, based on information corresponding to a lack of available resource of the first hub device being received from the first hub device.

The processor may be configured to, transmit the signal to disconnect the external device from the first hub device through the communication interface based on the first hub device performing an operation that consumes a resource of the first hub device more than a threshold value.

The processor may be configured to receive information corresponding to resource states of the plurality of hub devices from the plurality of hub devices through the communication interface at preset intervals.

The apparatus may be configured to, based on a request for registering a third hub device among the plurality of hub devices being received from an external server, register the third hub device among the plurality of hub devices, and obtain resource information of the third hub device from the third hub device through the communication interface.

A controlling method of an electronic apparatus according to one or more embodiments includes, based on a resource state of a first hub device, among a plurality of hub devices, having a resource condition unsatisfied to support control of an external device connected to the first hub device, transmitting to disconnect the external device from the first hub device, and transmitting a signal to connect the external device to a second hub device, among the plurality of hub devices, having a resource state that satisfies the resource condition to support the control of the external device.

The method may further include, based on a request to connect one of the plurality of hub devices to the external device being received from the external device, transmitting a signal to the first hub device as the one of the plurality of hub devices having a resource required to support an operation of the external device.

The resource required to support the operation of the external device may be a computing device enabled to support the operation of the external device.

The resource required to support the operation may be a communication interface that performs communication according to a communication protocol through which the external device performs communication.

The transmitting the signal to disconnect the external device from the first hub device may be based on an available resource of the first hub device being less than a resource required to control the external device.

The transmitting the signal to disconnect the external device from the first hub device may be based on information corresponding to a lack of available resource of the first hub device being received from the first hub device.

The transmitting a signal the signal to disconnect the external device from the first hub device may be based on the first hub device performing an operation that consumes a resource of the first hub device more than a threshold value.

The method may further include receiving information corresponding to resource states of the plurality of hub devices from the plurality of hub devices through the communication interface at preset intervals.

The method may further include, based on a request for registering a third hub device among the plurality of hub devices being received from an external server, register the third hub device among the plurality of hub devices, and obtain resource information of the third hub device from the third hub device.

In a non-transitory computer-readable recording medium including a program that executes a controlling method of an electronic apparatus, the controlling method includes, based on a resource state of a first hub device, among a plurality of hub devices, having a resource condition unsatisfied to support control of an external device connected to the first hub device, transmitting a signal to disconnect the external device from the first hub device, and transmitting a signal to connect the external device to a second hub device, among the plurality of hub devices, having a resource state that satisfies the resource condition to support the control of the external device.

The method may further include, based on a request to connect one of the plurality of hub devices to the external device being received from the external device, transmitting a signal to the first hub device as the one of the plurality of hub devices having a resource required to support an operation of the external device.

### BRIEF DESCRIPTION OF THE DRAWINGS

FIGS. 1A and 1B are views provided to explain a home network system according to one or more embodiments;

FIGS. 2A and 2B are views provided to explain a home network system according to one or more embodiments;

FIG. 3 is a block diagram provided to explain configuration of an electronic apparatus according to one or more embodiments;

FIG. 4 is a sequence view provided to explain how an electronic apparatus obtains resource states of a plurality of hub device connected to the electronic apparatus according to one or more embodiments;

FIG. 5 is a view provided to explain how an electronic apparatus registers a new hub device according to one or more embodiments;

FIG. 6 is a sequence view provided to explain how an electronic apparatus connects an external device according to one or more embodiments; and

FIG. 7 is a sequence view provided to explain how an electronic apparatus changes a hub device to which an external device is connected according to one or more embodiments.

### DETAILED DESCRIPTION OF EMBODIMENTS

Since the embodiments of the present disclosure may be variously modified and have several exemplary embodiments, specific exemplary embodiments of the disclosure will be illustrated in the drawings and be described in detail in the detailed description. However, it is to be understood that the disclosure is not limited to specific exemplary embodiments, but include all modifications, equivalents, and/or alternatives according to exemplary embodiments of the disclosure. Throughout the accompanying drawings, similar components may be denoted by similar reference numerals.

In describing the disclosure, when it is decided that a detailed description for the known functions or configurations related to the disclosure may unnecessarily obscure the gist of the disclosure, the detailed description therefor will be omitted.

In addition, the following exemplary embodiments may be modified in several different forms, and the scope and spirit of the disclosure are not limited to the following exemplary embodiments. Rather, these exemplary embodiments make the disclosure thorough and complete, and are provided to completely transfer the spirit of the disclosure to those skilled in the art.

Terms used in the disclosure are used only to describe specific exemplary embodiments rather than limiting the scope of the disclosure. Singular forms are intended to include plural forms unless the context clearly indicates otherwise.

In the disclosure, the expressions “have”, “may have”, “include” or “may include” used herein indicate existence of corresponding features (e.g., elements such as numeric values, functions, operations, or components), but do not exclude presence of additional features.

In the disclosure, the expressions “A or B”, “at least one of A or/and B”, or “one or more of A or/and B”, and the like may include any and all combinations of one or more of the items listed together. For example, the term “A or B”, “at least one of A and B”, or “at least one of A or B” may refer to all of the case (1) where at least one A is included, the case (2) where at least one B is included, or the case (3) where both of at least one A and at least one B are included.

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

In contrast, when an element (e.g., a first element) is referred to as being “directly coupled with/to” or “directly connected to” another element (e.g., a second element), it should be understood that there is no intervening element (e.g., a third element) in-between.

An expression “˜configured (or set) to” used in the disclosure may be replaced by an expression, for example, “suitable for,” “having the capacity to,” “˜designed to,” “˜adapted to,” “˜made to,” or “˜capable of” depending on a situation. A term “˜configured (or set) to” may not necessarily mean “specifically designed to” in hardware.

Instead, an expression “˜an apparatus configured to” may mean that an apparatus “is capable of” together with other apparatuses or components. For example, a “processor configured (or set) to perform A, B, and C” may mean a dedicated processor (e.g., an embedded processor) for performing the corresponding operations or a generic-purpose processor (e.g., a central processing unit (CPU) or an application processor) that may perform the corresponding operations by executing one or more software programs stored in a memory apparatus.

In exemplary embodiments, a “module” or a “unit” may perform at least one function or operation, and be implemented by hardware or software or be implemented by a combination of hardware and software. In addition, a plurality of “modules” or a plurality of “units” may be integrated into at least one module and be implemented by at least one processor except for a ‘module’ or a ‘unit’ that needs to be implemented by specific hardware.

Meanwhile, various elements and regions in the drawings are schematically drawn. Therefore, the technical concept of the disclosure is not limited by a relative size or spacing drawn in the accompanying drawings.

Hereinafter, embodiments of the present disclosure will be described in detail with reference to the accompanying drawings, so that those skilled in the art can easily implement them.

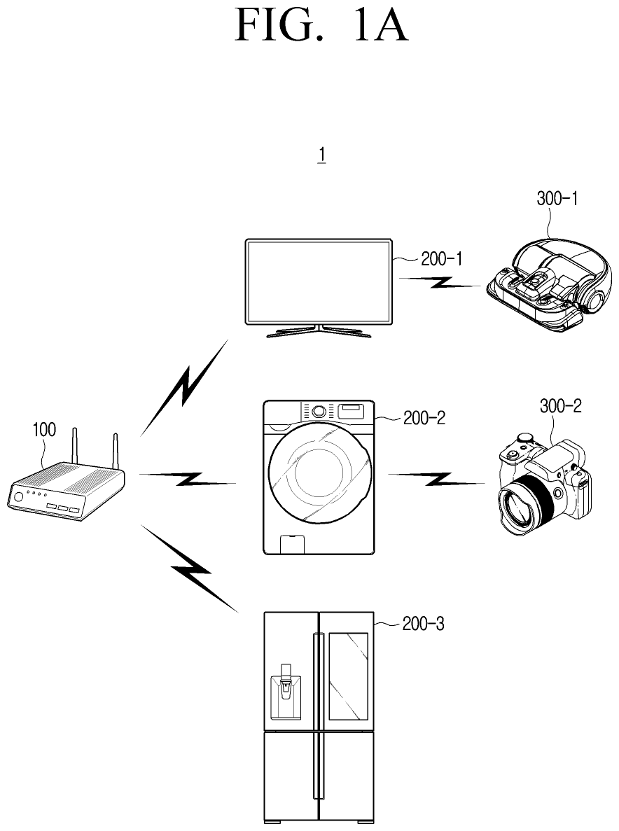

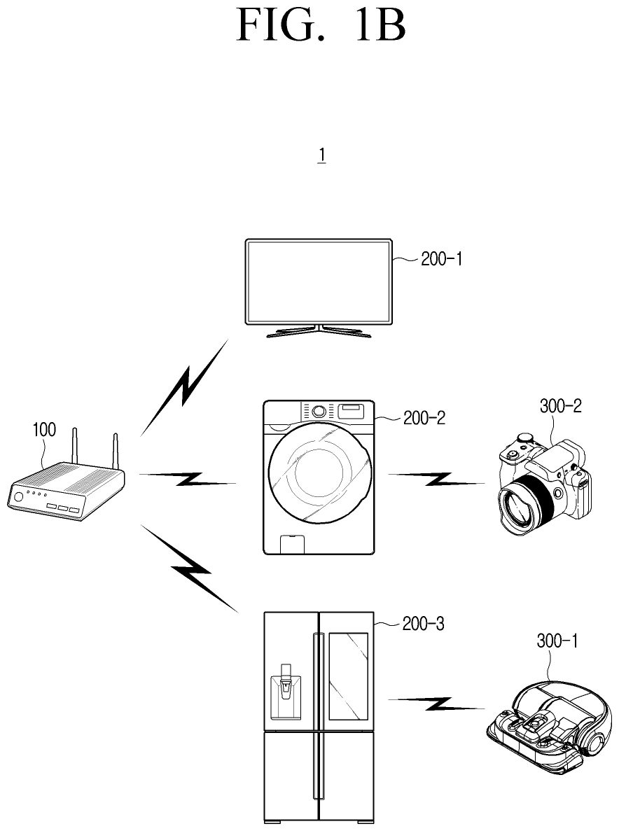

FIGS. 1A and 1B are views provided to explain a home network system according to one or more embodiments.

Referring to FIG. 1A, a home network system 1 may include an electronic apparatus 100, a plurality of hub devices 200-1, 200-2, 200-3, and at least one external device 300-1, 300-2.

In this case, each of the at least one external device 300-1, 300-2 may be connected to one of the plurality of hub devices 200-1, 200-2, 200-3 to perform various forms of operation.

Here, the connection can mean a state in which the external device and the hub device are performing communication, and the hub device controls the operation of the external device.

The electronic apparatus 100, the hub devices 200-1, 200-2, 200-3, and the external devices 300-1, 300-2 according to an embodiment may be at least one of various types of home appliances. For example, the electronic apparatus 100 or the hub device 200-1, 200-2, 200-3 may be at least one of, but not limited to, a television, a washing machine, and a refrigerator, and the external devices 300-1, 300-2 may be at least one of, but not limited to, a robot vacuum cleaner and a camera.

The aforementioned home appliances are only examples, and the electronic apparatus 100, the hub devices 200-1, 200-2, 200-3, and the external devices 300-1, 300-2 may be at least one of dishwasher, electric range, electric oven, air conditioner, clothing care device, dryer, microwave oven, vacuum cleaner, and monitor, in addition to the aforementioned home appliances.

The electronic apparatus 100 may perform communication with the plurality of hub devices 200-1, 200-2, 200-3, and may control the plurality of hub devices 200-1, 200-2, 200-3. In this case, the electronic apparatus 100 may control connection between the plurality of hub devices 200-1, 200-2, 200-3 and at least one external device 300-1, 300-2.

Specifically, the electronic apparatus 100 may adjust the hub device connected to the first external device 300-1 based on the resource state of the plurality of hub devices 200-1, 200-2, 200-3. For example, as illustrated in FIG. 1A, when a resource shortage event occurs in the first hub device 200-1 while the first external device 300-1 and the first hub device 200-1 are connected, the electronic apparatus 100 may connect the first external device 300-1 to the second hub device 200-2, as shown in FIG. 1B.

Meanwhile, “connection” in this disclosure may refer to a state in which communication is performed between a hub device and an external device, and the hub device controls the external device. In this case, the hub device and the external device may perform communication by forming a peer-to-peer (P2P) group, perform communication through a common access point (AP), or perform communication through an external server 10, but the present disclosure is not limited thereto. In addition, “connection” may be referred to as “pairing,” “interworking,” or the like.

In other words, the electronic apparatus 100 according to the present disclosure may dynamically change a connected device of at least one external device 300-1, 300-2 in response to a change in the resource state of the plurality of hub devices 200-1, 200-2, 200-3 in the home network system 1.

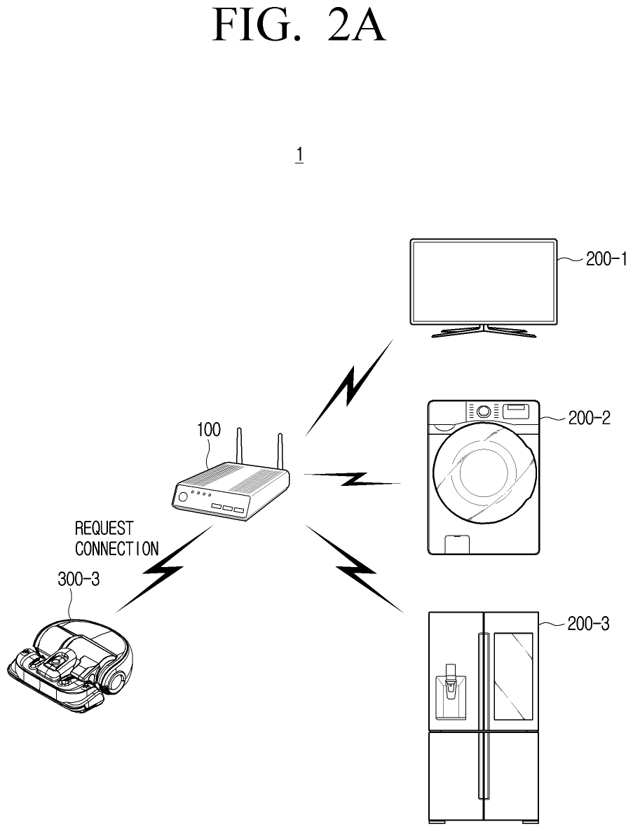

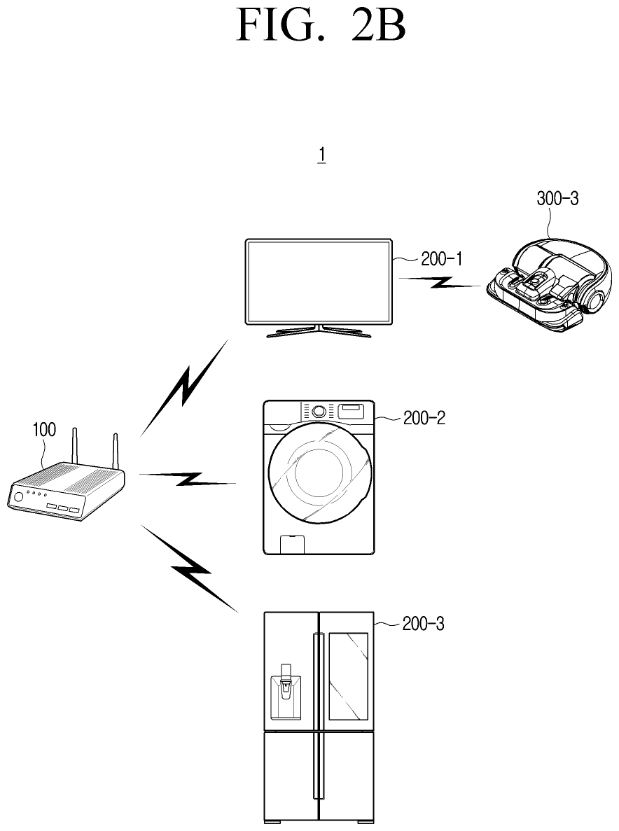

FIGS. 2A and 2B are views provided to explain a home network system according to one or more embodiments.

Referring to FIG. 2A, the electronic apparatus 100 may obtain a connection request from a new external device 300-3.

In addition, the electronic apparatus 100 may identify a hub device including a resource capable of supporting the operation of the new external device 300-3 from among the plurality of hub devices 200-1, 200-2, 200-3.

Specifically, the resource capable of supporting the operation of the new external device 300-3 may refer to a computing device capable of supporting the operation of the new external device 300-3.

For example, the new external device 300-3 may be a robot vacuum cleaner including a camera, and the resource capable of supporting the operation of the new external device 300-3 may be a computing device (e.g., a neural processing unit (NPU)) with image processing performance of a preset value or higher. Accordingly, a hub device including a computing device with image processing performance of a preset value or higher may perform image processing of the image captured by the camera of the robot cleaner together with the robot cleaner or independently.

In this case, the electronic apparatus 100 may identify the first hub device 200-1 including a computing device with image processing performance of a preset value or higher from among the plurality of hub devices 200-1, 200-2, and 200-3. Subsequently, the electronic apparatus 100 may connect the new external device 300-3 to the first hub device 200-1 from among the plurality of hub devices 200-1, 200-2, 200-3, as shown in FIG. 2B.

Alternatively, the new external device 300-3 may be a robot vacuum cleaner that performs communication via Zigbee communication protocol, and the resource capable of supporting the operation of the new external device 300-3 may be a communication interface that performs communication via the Zigbee communication protocol.

In this case, the electronic apparatus 100 may identify the first hub device 200-1 including a communication interface that performs communication via the Zigbee communication protocol from among the plurality of hub devices 200-1, 200-2, 200-3. Subsequently, the electronic apparatus 100 may connect the new external device 300-3 to the first hub device 200-1 from among the plurality of hub devices 200-1, 200-2, 200-3, as shown in FIG. 2B.

In other words, the electronic apparatus 100 according to the present disclosure may, in the home network system 1, connect an external device to a hub device for effectively supporting the operation of the external device, from among the plurality of hub devices 200-1, 200-2, 200-3, based on the resource included in the plurality of hub devices 200-1, 200-2, 200-3.

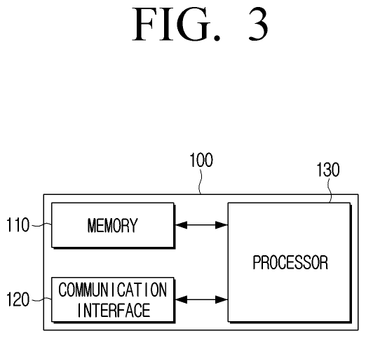

FIG. 3 is a block diagram provided to explain configuration of the electronic apparatus 100 according to one or more embodiments.

Referring to FIG. 3, the electronic apparatus 100 may include at least one of a memory 110, a communication interface 120, and a processor 130. The electronic apparatus 100 may further include other components in addition to the above components.

In addition to the examples described above, the electronic apparatus 100 may be implemented in a variety of forms, such as smartphones, televisions, smart TVs, set-top boxes, cell phones, personal digital assistants (PDAs), laptops, media players, e-book devices, digital broadcasting devices, navigation, kiosks, MP3 players, wearable devices, home appliances, and other mobile or non-mobile computing devices.

The memory 110 may store at least one instruction for the electronic apparatus 100. Further, the memory 110 may store an operating system (O/S) for operating the electronic apparatus 100. The memory 110 may also store various software programs or applications for operating the electronic apparatus 100 according to various embodiments of the present disclosure. The memory 110 may include a semiconductor memory such as a flash memory, or magnetic storage media such as a hard disk, or the like.

Specifically, the memory 110 may store various software modules for operating the electronic apparatus 100 according to various embodiments of the present disclosure, and the processor 130 may control the operation of the electronic apparatus 100 by executing various software modules stored in the memory 130. In other words, the memory 110 may be accessed by the processor 130, and the data may be read/written/modified/deleted/updated, etc. by the processor 130.

Meanwhile, the term ‘memory 110’ may be used in this disclosure to include ROM (not shown), RAM (not shown) in processor 130, or a memory card (not shown) (e.g., micro SD card, memory stick) mounted in the electronic apparatus 100.

The communication interface 120 includes circuitry and is capable of performing communication with external devices and servers. The communication interface 120 may perform communication with an external device or a server based on a wired or wireless communication method. The communication interface 120 may include a Bluetooth module (not shown), a Wi-Fi module (not shown), an infrared (IR) module, a Local Area Network (LAN) module, an Ethernet module, etc. Here, each communication module may be implemented in the form of at least one hardware chip. In addition to the above-described communication methods, the wireless communication module may include at least one hardware chip that performs communication according to various wireless communication protocols such as Zigbee, Universal Serial Bus (USB), Mobile Industry Processor Interface Camera Serial Interface (MIPI CSI), 3G 3rd Generation (3G), 3rd Generation Partnership Project (3GPP), and Long Term Evolution (LTE), LTE Advanced (LTE-A), 4th Generation (4G), and 5th Generation (5G). However, this is only an example, and the communication interface 120 may use at least one communication module among various communication modules.

The processor 130 may control the overall operations and functions of the electronic apparatus 100. Specifically, the processor 130 may be connected to the configuration of the electronic apparatus 100 that includes the memory 110, and may control the overall operations of the electronic apparatus 100 by executing at least one instruction stored in the memory 110, as described above.

The processor 130 may be implemented in various ways. For example, the processor 130 may be implemented as at least one of an Application Specific Integrated Circuit (ASIC), a logic integrated circuit, an embedded processor, a Micom, a microprocessor, hardware control logic, a hardware Finite State Machine (FSM), or a Digital Signal Processor (DSP).

In particular, the processor 130 may include one or more processors. Specifically, one or more processors may include one or more of a central processing unit (CPU), a graphics processing unit (GPU), an accelerated processing unit (APU), a many integrated core (MIC), a digital signal processor (DSP), a neural processing unit (NPU), a main processing unit (MPU), a hardware accelerator, or a machine learning accelerator. The one or more processors may control one or any combination of the other components of the electronic apparatus, and may perform communication-related operations or data processing. The one or more processors may execute one or more programs or instructions stored in a memory. For example, the one or more processors may perform a method according to an embodiment by executing one or more instructions stored in the memory.

When a method according to an embodiment includes a plurality of operations, the plurality of operations may be performed by one processor or by a plurality of processors. In other words, when a first operation, a second operation, and a third operation are performed by the method according to an embodiment, all of the first operation, the second operation, and the third operation may be performed by the first processor, or the first operation and the second operation may be performed by the first processor (e.g., a general-purpose processor) and the third operation may be performed by the second processor (e.g., an artificial intelligence-dedicated processor).

The one or more processors may be implemented as a single core processor comprising a single core, or as one or more multicore processors including a plurality of cores (e.g., homogeneous multicore or heterogeneous multicore). When the one or more processors are implemented as multicore processors, each of the plurality of cores included in a multicore processor may include a processor internal memory, such as a cache memory and an on-chip memory, and a common cache shared by the plurality of cores may be included in the multicore processor. Further, each of the plurality of cores (or some of the plurality of cores) included in the multi-core processor may independently read and perform program instructions to implement the method according to an embodiment, or all (or some) of the plurality of cores may be coupled to read and perform program instructions to implement the method according to an embodiment.

When a method according to an embodiment includes a plurality of operations, the plurality of operations may be performed by one core of a plurality of cores included in a multi-core processor, or may be performed by a plurality of cores. For example, when a first operation, a second operation, and a third operation are performed by a method according to an embodiment, all of the first operation, the second operation, and the third operation may be performed by the first core included in the multi-core processor, or the first operation and the second operation may be performed by the first core included in the multi-core processor and the third operation may be performed by the second core included in the multi-core processor.

In the embodiments of the present disclosure, the processor 130 may mean a system-on-chip (SoC) in which one or more processors and other electronic components are integrated, a single-core processor, a multi-core processor, or a core included in a single-core processor or multi-core processor. Here, the core may be implemented as CPU, GPU, APU, MIC, DSP, NPU, hardware accelerator, or machine learning accelerator, etc., but the core is not limited to the embodiments of the present disclosure.

The operation of the processor 130 to implement various embodiments of the present disclosure may be implemented through a plurality of modules.

Specifically, data for the plurality of modules according to the present disclosure may be stored in the memory 110, and processor 130 may access the memory 110 to load data for the plurality of modules into a memory or a buffer within the processor 130, and then use the plurality of modules to implement various embodiments of the present disclosure.

However, at least one of the plurality of modules according to the present disclosure may also be implemented as hardware and included within the processor 130 in the form of a system on chip.

Alternatively, at least one of the plurality of modules according to the present disclosure may be implemented as a separate external device, and the electronic apparatus 100 and each module may perform communication to perform the operations according to the present disclosure. Hereinafter, the operation of the processor 130 according to the present disclosure will be described in detail with reference to the accompanying drawings,.

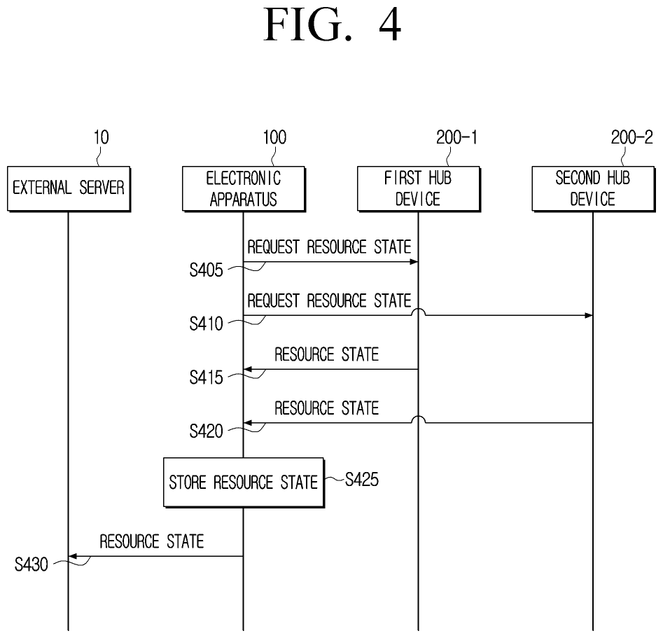

FIG. 4 is a sequence view provided to explain how the electronic apparatus 100 obtains resource states of a plurality of hub device connected to the electronic apparatus 100 according to one or more embodiments.

Referring to FIG. 4, the electronic apparatus 100 may transmit a resource state request signal to each of the plurality of hub devices 200-1, 200-2 (S405, S410). In this case, the electronic apparatus 100 may transmit the resource state request signal to each of the plurality of hub devices 200-1, 200-2 in a multicast manner. The electronic apparatus 100 may transmit the resource state request signal to the plurality of hub devices 200-1, 200-2 at a preset interval, but is not limited thereto.

In the present disclosure, the plurality of hub devices 200-1, 200-2 may be devices which are controlled by the electronic apparatus 100 and also control at least one external device. Specifically, the plurality of hub devices 200-1, 200-2 may be devices that are registered in profile information of a plurality of hub devices stored in the electronic apparatus 100. Here, the profile information of the plurality of hub devices may include identification information of the hub devices and information about resource states of the hub devices.

Alternatively, the plurality of hub devices 200-1, 200-2 may be hub devices registered to a user account logged in on the electronic apparatus 100. In this case, the hub device registered to the user account may be a device registered to information corresponding to the user account. In this case, the information corresponding to the user account may include profile information of the plurality of hub devices 200-1, 200-2 that includes a list of the plurality of hub devices 200-1, 200-2. The information corresponding to the user account may be stored in the electronic apparatus 100 or may be stored in an external server. When the information corresponding to the user account is stored in an external server, the electronic apparatus 100 may receive the profile information of the plurality of hub devices from the external server.

In the present disclosure, the electronic apparatus 100 may be referred to as a “main hub device” that controls the plurality of hub devices 200-1, 200-2, and the plurality of hub devices 200-1, 200-2 may be referred to as “sub-hub devices” that are controlled by the main hub device, but the present disclosure is not limited thereto. In this case, the electronic apparatus 100 may also operate as a hub device to control an external device to control the external device by being connected to the external device without going through the plurality of hub devices 200-1, 200-2.

In the present disclosure, a resource state of a hub device may include at least one of hardware resource usage of the hub device, hardware resource available usage of the hub device, hardware resource included in the hub device, available hardware resource of the hub device, or communication protocol through which the hub device performs communications.

Specifically, the hardware resource of the hub device may include at least one of a processor of the hub device or a memory of the hub device.

The available hardware resource of the hub device may include at least one of a neural processing unit (NPU), a display, or a speaker, but is not limited thereto.

The communication protocol through which the hub device performs communication may include at least one of ZigBee, Z-Wave, or Bluetooth, but is not limited thereto.

In addition, the electronic apparatus 100 may obtain information about the resource state of each of the plurality of hub devices 200-1, 200-2 from the plurality of hub devices 200-1, 200-2 (S415, S420). In other words, the electronic apparatus 100 may receive information corresponding to the resource state of the plurality of hub devices 200-1, 200-2 from the plurality of hub devices 200-1, 200-2.

In this case, the electronic apparatus 100 may receive identification information of each of the plurality of hub devices 200-1, 200-2 together with the resource state of each of the plurality of hub devices 200-1, 200-2 from each of the plurality of hub devices 200-1, 200-2.

The electronic apparatus 100 may store the received identification information of the plurality of hub devices 200-1, 200-2 and the resource state of the plurality of hub devices 200-1, 200-2 in the memory 110 (S425).

In this case, when the electronic apparatus 100 is connected to the network, the electronic apparatus 100 may transmit the identification information of the plurality of hub devices 200-1, 200-2 and the resource state of the plurality of hub devices 200-1, 200-2 to the external server 10 (S430) to synchronize the resource state information of the hub devices stored in the electronic apparatus with the resource state information of the hub devices stored in the external server 10.

Meanwhile, in the present disclosure, the external server 10 may include a communication module capable of performing communication with other servers, external devices, or user terminal devices, at least one processor capable of processing data received from other servers, home appliances, or user terminal devices, and at least one memory capable of storing programs for processing data or processed data. The external server 10 may be implemented as various computing devices, such as a workstation, a cloud, a data drive, a data station, and the like. The external server 10 may be implemented as one or more servers that are physically or logically separated based on functions, detailed configuration of the functions, or data, and may transmit and receive data and process the data through communication between servers.

The external server 10 may perform functions such as managing user accounts, registering external devices in association with user accounts, and managing or controlling registered external devices. For example, a user may connect to the external server 10 via a user terminal device and create a user account. The user account may be identified by a username and password set by the user. The external server 10 may register an external device to the user account according to a preset procedure. For example, the external server 10 may associate identification information of the external device (e.g., a serial number or MAC address, etc.) with the user account to register, manage, and control the external device. The user terminal device may include a communication module capable of performing communication with an external device or an external server, a user interface for receiving a user input or outputting information to the user, at least one processor for controlling the operation of the user terminal device, and at least one memory for storing a program for controlling the operation of the user terminal device.

Meanwhile, according to one or more embodiments of the present disclosure, a registration request is received from a new hub device, the electronic apparatus 100 may register the new hub device with a list of a plurality of hub devices controlled by the electronic apparatus 100.

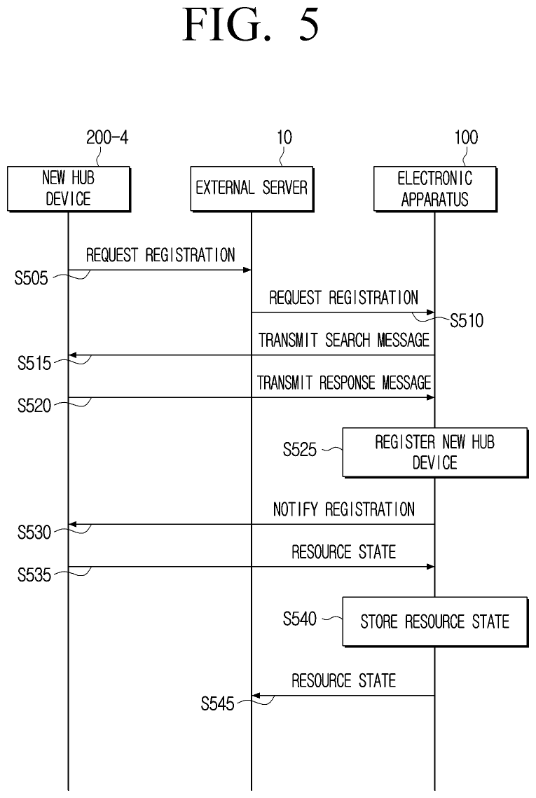

FIG. 5 is a view provided to explain how the electronic apparatus 100 adds a new hub device in a list of a plurality of hub devices according to one or more embodiments.

Referring to FIG. 5, a new hub device 200-4 may transmit a registration request to the external server 10 (S505). In this case, the registration request may be a request for registering the new hub device 200-4 with a list of a plurality of hub devices.

Specifically, the list of the plurality of hub devices may be included in the account information of a logged-in user of the electronic apparatus 100. In this case, the user account information may include profile information of a plurality of hub devices that include a list of the plurality of hub devices. Here, the user account information may be stored in the external server 10, but is not limited thereto. In addition, the registration request may be a request for registering the new hub device 200-4 with the list of the plurality of hub devices included in the user account information.

Accordingly, the external server 10 may register the new hub device 200-4 to the user account.

Subsequently, the external server 10 may transmit a registration request for the new hub device 200-4 to the electronic apparatus 100 (S510). In this case, the external server 10 may transmit identification information of the new hub device 200-4 to the electronic apparatus 100.

Meanwhile, the new hub device 200-4 may transmit a registration request to the electronic apparatus 100 without going through the external server 10. In this case, the registration request may be a request for registering the new hub device 200-4 in a list of a plurality of hub devices stored in the memory 110. When a registration request for the new hub device 200-4 is received, the electronic apparatus 100 may search for the new hub device 200-4.

In this case, when a registration request for the new hub device 200-4 is received, the electronic apparatus 100 may display a UI for confirming whether the new hub device 200-4 is registered, and when a user input for registering the new hub device 200-4 is obtained via the displayed UI, register the new hub device 200-4 in a list of the plurality of hub devices. However, the present disclosure is not limited thereto.

Specifically, the electronic apparatus 100 may transmit a search message to search for the new hub device 200-4 on the network to which the electronic apparatus 100 is connected, to the new hub device 200-4 (S515). In this case, the search message may include identification information of the new hub device 200-4.

When the search message including identification information of the new hub device 200-4 is received, the new hub device 200-4 may transmit a response message to the electronic apparatus (S520).

When the response message is received, the electronic apparatus 100 may register the new hub device 200-4 in a list of the plurality of hub devices controlled by the electronic apparatus 100 (S525). Specifically, the memory 110 may store profile information of the plurality of hub devices, including a list of the plurality of hub devices. The electronic apparatus 100 may register the new hub device 200-4 with the list of the plurality of hub devices stored in the memory 110.

Accordingly, the electronic apparatus 100 may perform communication by forming a peer-to-peer group with the new hub device 200-4, perform communication via an AP, or perform communication via the external server 10, but is not limited thereto. When the new hub device 200-4 is registered with the list of the plurality of hub devices, the electronic apparatus 100 may transmit information indicating that the new hub device 200-4 is registered with the list of the plurality of hub devices, to the new hub device 200-4.

Subsequently, the electronic apparatus 100 may receive resource state information of the new hub device 200-4 from the new hub device 200-4 via the communication interface 120 (S535).

In this case, the method of obtaining the resource state information of the new hub device 200-4 by the electronic apparatus 100 may be the same as described with reference to FIG. 4, but the present disclosure is not limited thereto.

The electronic apparatus 100 may store the received resource state information of the new hub device 200-4 in the memory 110 (S540).

Subsequently, the electronic apparatus 100 may transmit the resource state information of the new hub device to the external server (S545) to synchronize the resource state information of the new hub device 200-4 stored in the electronic apparatus 100 with the resource state information of the new hub device 200-4 stored in the external server 10.

According to one or more embodiments, when a connection request signal is received from an external device, the electronic apparatus 100 may connect the external device to one of a plurality of hub devices. In this case, the electronic apparatus 100 may connect the external device to a hub device that includes resources capable of supporting the operation of the external device.

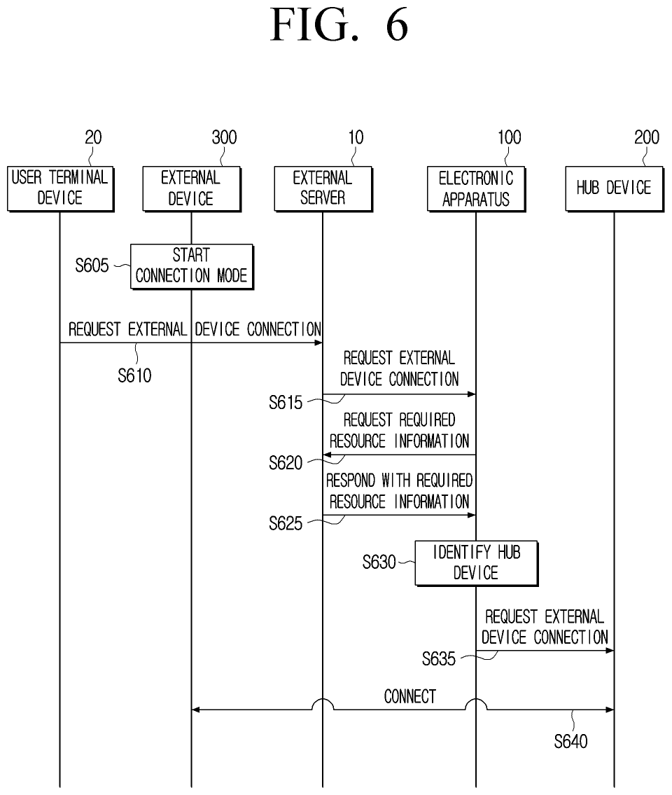

FIG. 6 is a sequence view provided to explain how the electronic apparatus 100 connects an external device 300 according to one or more embodiments.

Referring to FIG. 6, when a user input for performing a connection mode is obtained, the external device 300 may initiate the connection mode (S605). In this case, the external device 300 may obtain the user input via a user interface of the external device 300, or may obtain the user input information for performing the connection mode from a user terminal device 20. Once the connection mode is initiated, the external device 300 may transmit a request signal corresponding to connection with one of a plurality of hub devices. When a connection request is received while the external device 300 is operating in the connection mode, the external device 300 may be connected to the hub device that transmitted the connection request.

Specifically, the user terminal device 20 may transmit a request for connecting the external device 300 to the external server 10 (S610). In this case, when a user input for selecting the external device 300 among at least one device operating in the connection mode is obtained, the user terminal device 20 may transmit a request for connecting the external device 300 to the hub device, to the external server 10.

Subsequently, the external server 10 may transmit a request for connecting the external device 300 to the electronic apparatus 100 (S615).

However, the present disclosure is not limited thereto, and the external device 300 may transmit a request for connecting the external device 300 to the external server 10, and the external server 10 may transmit a request for connecting the external device 300 to the electronic apparatus 100.

Alternatively, the external device 300 may transmit a request for connecting the external device 300 directly to the electronic apparatus 100.

Alternatively, the user terminal device 20 may transmit a request for connecting the external device 300 directly to the electronic apparatus 100 without going through the external server 10.

When a request for connecting the external device 300 is received, the electronic apparatus 100 may transmit a request for resource information required to support the operation of the external device 300 to the external server 10 (S620).

Subsequently, the electronic apparatus 100 may receive the resource information required to support the operation of the external device 300 from the external server 10 (S625). However, the present disclosure is not limited thereto, and the electronic apparatus 100 may transmit a request for the resource information required to support the operation of the external device 300 to the external device 300 or the user terminal device 20, and receive the resource information.

When the resource information required to support the operation of the external device 300 is received, the electronic apparatus 100 may identify a hub device 200 that satisfies the resource condition required to support the operation of the external device 300 (S630).

Subsequently, the electronic apparatus 100 may transmit a request signal for connecting the external device 300 to the identified hub device 200 (S635).

When the connection request signal to connect the external device 300 is received, the hub device 200 may perform connection with the external device 300 (S640).

Meanwhile, when the electronic apparatus 100 satisfies the resource condition required to support the operation of the external device 300, the electronic apparatus 100 may be connected to the external device 300 by transmitting a signal corresponding to the connection between the electronic apparatus 100 and the external device 300 to the external device 300. Subsequently, the electronic apparatus 100 may control the connected external device 300.

Meanwhile, according to one or more embodiments, when an event in which the resource state of a hub device to which the external device is connected does not satisfy a preset resource condition occurs, the electronic apparatus may connect the external device to another hub device that is different from the hub device to which the external device is connected among the plurality of hub devices.

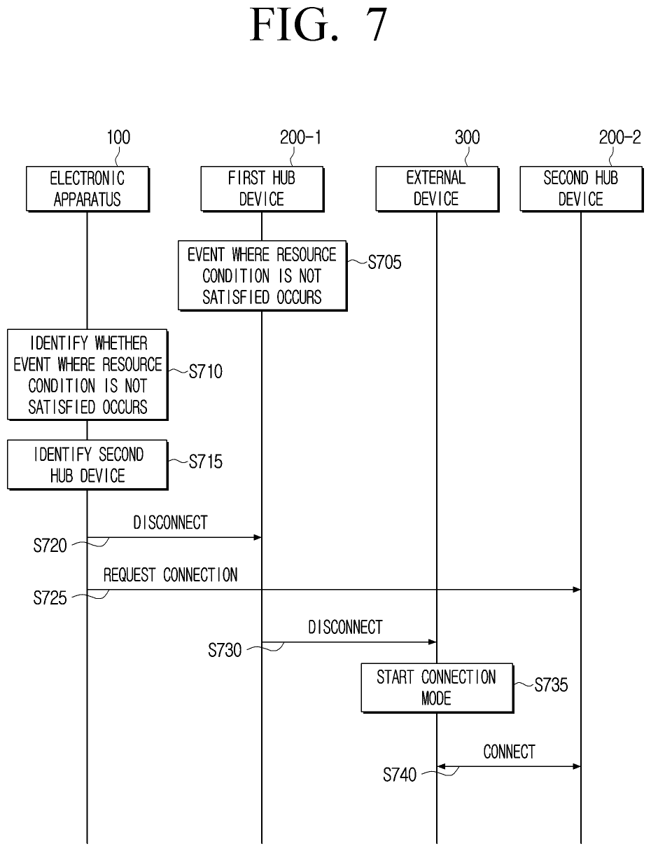

FIG. 7 is a sequence view provided to explain how the electronic apparatus 100 changes a hub device to which an external device is connected according to one or more embodiments.

Referring to FIG. 7, an event in which a resource state of the first hub device 200-1 to which the external device 300 is connected does not satisfy a preset resource condition may occur (S705).

The electronic apparatus 100 may identify whether an event in which the resource state of the first hub device 200-1 to which the external device 300 is connected among the plurality of hub devices does not satisfy a preset resource condition occurs (S710). In this case, the electronic apparatus 100 may identify whether an event in which the resource state of the first hub device 200-1 does not satisfy a preset resource condition occurs, based on information related to the resource state received from the first hub device 200-1.

Here, the preset resource condition may be any resource condition required for the hub device to control the external device.

Specifically, an event in which the resource state of the first hub device 200-1 does not satisfy the resource condition for controlling the external device 300 may be an event in which the available resource of the first hub device 200-1 is less than the resource required to control the external device 300. In other words, it may be an event in which the available resource of the first hub device 200-1 is less than the resource required to control the external device 300.

Specifically, the electronic apparatus 100 may identify whether an event in which the available resource of the first hub device 200-1 is less than the resource for controlling the external device 300 occurs, based on the resource state of the plurality of hub devices stored in the memory 110.

In the present disclosure, the available resource of the hub device may refer to the available processing power of the CPU of the hub device or available capacity of the memory of the hub device, but is not limited thereto.

For example, the memory capacity required to control the external device 300 may be 100 MB. When the available memory capacity of the first hub device 200-1 becomes less than 100 MB, the electronic apparatus 100 may identify that an event in which the resource state of the first hub device 200-1 does not satisfy the resource condition for controlling the external device 300 has occurred. In other words, the electronic apparatus 100 may receive information about the resource state including the available memory capacity of the first hub device 200-1, from the first hug device 200-1. When the available memory capacity of the first hub device 200-1 is less than a preset memory capacity, the electronic apparatus 100 may identify that the resource state of the first hub device 200-1 does not satisfy the resource condition required to control the external device 300.

Alternatively, an event in which the resource state of the first hub device 200-1 does not satisfy the resource condition for controlling the external device 300 may be an event in which the electronic apparatus 100 receives information corresponding to lack of the available resource of the first hub device 200-1, from the first hub device 200-1. Here, the information corresponding to lack of the available resource may be information indicating lack of the available resource of the first hub device 200-1.

For example, when the available memory capacity of the first hub device 200-1 becomes less than 100 MB, the first hub device 200-1 may transmit information indicating lack of the available resource of the first hub device 200-1 to the electronic apparatus 100. In this case, the electronic apparatus 100 may identify that an event in which the resource state of the first hub device 200-1 does not satisfy the resource condition for controlling the external device 300 has occurred.

Alternatively, an event in which the resource state of the first hub device 200-1 does not satisfy the resource condition for controlling the external device 300 may be an event in which the first hub device 200-1 performs a preset operation.

Here, the preset operation may be an operation in which the first hub device 200-1 uses the resource of the first hub device 200-1 more than a threshold value. Specifically, the preset operation may be the operation of using the CPU of the first hub device 200-1 more than a threshold value. Alternatively, the preset operation may be the operation of using the memory of the first hub device 200-1 more than a threshold value. Alternatively, the preset operation may be the operation of outputting a camera image while a video of a certain resolution (e.g., 4K resolution) or higher is being played.

Alternatively, the event in which the resource state of the first hub device 200-1 does not satisfy the resource condition for controlling the external device 300 may be an event in which a resource supporting the operation of the external device 300 is unavailable. Specifically, an event in which the resource for supporting the operation of the external device 300 is unavailable may be a case where the resource for supporting the operation of the external device 300 is in use, or an error occurs. For example, when the resource for supporting the operation of the external device 300 is a neural network processing device, an event in which the resource condition for controlling the external device 300 is not satisfied may be a case where the neural processing device is externally in use or unavailable.

When the occurrence of an event in which the resource condition is not satisfied is identified (i.e., the resource state of the first hub device 200-1 does not satisfy the resource condition for controlling the external device 300), the electronic apparatus 100 may identify the second hub device 200-2 that satisfies the resource condition for controlling the external device 300 among the plurality of hub devices (S715).

Subsequently, the electronic apparatus 100 may transmit a disconnection request to the first hub device 200-1 via the communication interface 120 (S720), and transmit a connection request with the external device to the second hub device 200-2 (S725). Here, the disconnection request may be a signal corresponding to disconnection between the first hub device 200-1 and the external device 300. The connection request may be a signal corresponding to connection between the second hub device 200-2 and the external device 300. When the connection with the first hub device 200-1 is released (S730), the external device 300 may initiate the connection mode (S735).

The external device 300 may be connected to the second hub device 200-2 (S740).

Meanwhile, the above embodiments describe that the electronic apparatus 100 controls connection and disconnection between a plurality of hub devices and an external device, but it is also possible for the electronic apparatus 100 to function as a hub device, and the electronic apparatus 100 may be connected to the external device 300, or connection between the electronic apparatus 100 and the external device 300 may be released. Meanwhile, according to the above description, the electronic apparatus 100 may change the device connected to the external device 300 from the first hub device 200-1 to the second hub device 200-2, but the present disclosure is not limited thereto. The electronic apparatus 100 may change the device connected to the external device 300 from the first hub device 200-1 to the electronic apparatus 100. Alternatively, the electronic apparatus 100 may disconnect the external device 300 connected to the electronic apparatus 100, and connect the external device 300 to the first hub device 200-1.

Specifically, when the resource condition of the first hub device 200-1 does not satisfy the resource condition for controlling the external device 300 while the first hub device 200-1 and the external device 300 are connected, the electronic apparatus 100 that satisfies the resource condition for controlling the external device 300 may be connected to the external device 300 and control the connected external device 300.

In other words, when the resource state of the first hub device 200-1 to which the external device 300 is connected among the plurality of hub devices 200-1, 200-2 does not satisfy the resource condition for controlling the external device, the electronic apparatus 100 may transmit a signal corresponding to disconnection between the first hub device 200-1 and the external device 300 to the first hub device 200-1 via the communication interface 120. In addition, the electronic apparatus 100 of which resource state satisfies the condition for controlling the external device 300 among the electronic apparatus 100 and the plurality of hub devices 200-1, 200-2 may transmit a signal corresponding to connection between the electronic apparatus 100 and the external device 300 to the external device 300 via the communication interface 120.

Alternatively, when the resource state of the electronic apparatus 100 does not satisfy the resource condition for controlling the external device 300 while the electronic apparatus 100 is connected to the external device 300, the electronic apparatus 100 may release connection between the electronic apparatus 100 and from the external device 300, and connect the external device 300 to the first hub device 200-1 that satisfies the resource condition for controlling the external device 300.

In other words, when the resource state of the electronic apparatus 100 associated with the external device 300 does not satisfy the resource condition for controlling the external device 300, the electronic apparatus 100 may release the connection between the electronic apparatus 100 and the external device 300. Subsequently, the electronic apparatus 100 may transmit a signal corresponding to connection between the external device 300 and the first hub device 200-1 that satisfies the resource condition for controlling the external device 300 among the plurality of hub devices 200-1, 200-2 to the first hub device 200-1 via the communication interface 120.

Each of the various embodiments has been described above, but each embodiment is not necessarily implemented individually, and may be implemented in one product as a whole or partially combined with at least one other embodiment.

Meanwhile, terms “˜er/or” or “module” used in the disclosure may include units configured by hardware, software, or firmware, and may be used compatibly with terms such as, for example, logics, logic blocks, parts, circuits, or the like. The “˜er/or” or “module” may be an integrally configured part or a minimum unit performing one or more functions or a part thereof. For example, the module may be configured by an application-specific integrated circuit (ASIC).

The above-described various embodiments may be implemented as software including instructions stored in machine-readable storage media, which can be read by machine (e.g.: computer). The machine refers to a device that calls instructions stored in a storage medium, and can operate according to the called instructions, and the device may include an electronic apparatus 100 according to the aforementioned embodiments. In case an instruction is executed by a processor, the processor may perform a function corresponding to the instruction by itself, or by using other components under its control. An instruction may include a code that is generated or executed by a compiler or an interpreter. The machine-readable storage medium may be provided in the form of a non-transitory storage medium. Here, the term “non-transitory” means that the storage medium is tangible without including a signal, and does not distinguish whether data are semi-permanently or temporarily stored in the storage medium.

According to one or more embodiments, a method according to the above-described various embodiments may be included and provided in a computer program product. The computer program product may be traded as a product between a seller and a purchaser. The computer program product may be distributed in the form of a storage medium (for example, a compact disc read only memory (CD-ROM)) that may be read by the machine or online through an application store (for example, PlayStore™). In case of the online distribution, at least a portion of the computer program product may be at least temporarily stored in a storage medium such as a memory of a server of a manufacturer, a server of an application store, or a relay server or be temporarily generated.

Each of the components (for example, modules or programs) according to various embodiments described above may include a single entity or a plurality of entities, and some of the corresponding sub-components described above may be omitted or other sub-components may be further included in the various embodiments. Alternatively or additionally, some components (e.g., modules or programs) may be integrated into one entity and perform the same or similar functions performed by each corresponding component prior to integration. Operations performed by the modules, the programs, or the other components according to the various embodiments may be executed in a sequential manner, a parallel manner, an iterative manner, or a heuristic manner, or at least some of the operations may be performed in a different order or be omitted, or other operations may be added.

What is claimed is:

1. An electronic apparatus comprising:
a communication interface;
a memory configured to store at least one instruction; and
a processor connected to the memory to control the electronic apparatus, wherein the processor is configured to:
based on a resource state of a first hub device, among a plurality of hub devices, having a resource condition unsatisfied to support control of an external device connected to the first hub device, transmit a signal to disconnect the external device from the first hub device through the communication interface; and
transmit a signal to connect the external device to a second hub device, among the plurality of hub devices, having a resource state that satisfies the resource condition to support the control of the external device through the communication interface.

2. The electronic apparatus as claimed in claim 1,
wherein the processor is configured to:
based on a request to connect one of the plurality of hub devices to the external device being received from the external device, transmit a signal to the first hub device as the one of the plurality of hub devices having a resource required to support an operation of the external device through the communication interface.

3. The electronic apparatus as claimed in claim 2,
wherein the resource required to support the operation of the external device is a computing device enabled to support the operation of the external device.

4. The electronic apparatus as claimed in claim 2,
wherein the resource required to support the operation of the external device is a respective communication interface that performs communication according to a communication protocol through which the external device performs communication.

5. The electronic apparatus as claimed in claim 1,
wherein the processor is configured to:
transmit the signal to disconnect the external device from the first hub device through the communication interface based on an available resource of the first hub device being less than a resource required to control the external device.

6. The electronic apparatus as claimed in claim 1,
wherein the processor is configured to:
transmit the signal to disconnect the external device from the first hub device through the communication interface based on information corresponding to a lack of available resource of the first hub device being received from the first hub device.

7. The electronic apparatus as claimed in claim 1,
wherein the processor is configured to:
transmit the signal to disconnect the external device from the first hub device through the communication interface based on the first hub device performing an operation that consumes a resource of the first hub device more than a threshold value.

8. The electronic apparatus as claimed in claim 1,
wherein the processor is configured to:
receive information corresponding to resource states of the plurality of hub devices from the plurality of hub devices through the communication interface at preset intervals.

9. The electronic apparatus as claimed in claim 1,
wherein the processor is configured to:
based on a request for registering a third hub device among the plurality of hub devices being received from an external server, register the third hub device among the plurality of hub devices; and
obtain resource information of the third hub device from the third hub device through the communication interface.

10. A controlling method of an electronic apparatus, the controlling method comprising:
based on a resource state of a first hub device, among a plurality of hub devices, having a resource condition unsatisfied to support control of an external device connected to the first hub device, transmitting a signal to disconnect the external device from the first hub device; and
transmitting a signal to connect the external device to a second hub device, among the plurality of hub devices, having a resource state that satisfies the resource condition to support the control of the external device.

11. The controlling method as claimed in claim 10, further comprising:
based on a request to connect one of the plurality of hub devices to the external device being received from the external device, transmitting a signal to the first hub device as the one of the plurality of hub devices having a resource required to support an operation of the external device.

12. The controlling method as claimed in claim 11, wherein the resource required to support the operation of the external device is a computing device enabled to support the operation of the external device.

13. The controlling method as claimed in claim 11, wherein the resource required to support the operation is a communication interface that performs communication according to a communication protocol through which the external device performs communication.

14. The controlling method as claimed in claim 10, wherein the transmitting the signal to disconnect the external device from the first hub device is based on an available resource of the first hub device being less than a resource required to control the external device.

15. A non-transitory computer-readable recording medium including a program that executes a controlling method of an electronic apparatus, the controlling method comprising:
based on a resource state of a first hub device, among a plurality of hub devices, having a resource condition unsatisfied to support control of an external device, transmitting a signal to disconnect the external device from the first hub device; and
transmitting a signal to connect the external device to a second hub device, among the plurality of hub devices, having a resource state that satisfies the resource condition to support the control of the external device.
